(19) United States
(12) Patent Application Publication
(10) Pub. No.: US 2024/0117933 A1
(43) Pub. Date: Apr. 11, 2024

(54) TANK

(71) Applicant: TOYOTA JIDOSHA KABUSHIKI KAISHA, Toyota-shi (JP)

(72) Inventor: Kazuki FUJII, Toyota-shi (JP)

(73) Assignee: TOYOTA JIDOSHA KABUSHIKI KAISHA, Toyota-shi (JP)

(21) Appl. No.: 18/474,009

(22) Filed: Sep. 25, 2023

(30) Foreign Application Priority Data
Oct. 5, 2022 (JP) 2022-160843

(51) Int. Cl. F17C 1/14

(52) U.S. Cl. CPC F17C 1/14; F17C 2201/0109; F17C 2203/012; F17C 2203/0604; F17C 2203/0619; F17C 2203/0646; F17C 2203/0673; F17C 2209/2109; F17C 2209/2154; F17C 2209/23; F17C 2221/012

(57) ABSTRACT

Provided is a tank that can lead to suppressed corrosion on a mouthpiece. The tank includes: a liner; and a mouthpiece disposed in an opening part of the liner, wherein a surface of the mouthpiece is aluminum, an anodized layer is provided over the surface of the mouthpiece, the anodized layer is partially a sealing part where a sealing layer is formed, and a rest of the anodized layer is partially a non-sealing part where the sealing layer is not formed, and the liner is disposed so as to straddle a boundary between the sealing part and the non-sealing part.

### CROSS-REFERENCE TO RELATED APPLICATION

This application claims priority to Japanese Patent Application No. 2022-160843 filed on Oct. 5, 2022, incorporated herein by reference in its entirety.

### FIELD

The present disclosure relates to tanks.

### BACKGROUND

Patent literature 1 discloses that a liner groove inside a mouthpiece is provided with plural holes to prevent a fall from the liner groove.

Patent literature 2 discloses the method of producing a tank comprising: anodizing the surface of a mouthpiece which is aluminum; while a mask is partially formed on the anodized surface, sealing the rest of the anodized surface; and thereafter, filling the part where the mask was formed with a liner material.

### CITATION LIST

### Patent Literature

Patent Literature 1: JP 2012-514727 A
Patent Literature 2: JP 2017-089674 A

### SUMMARY

### Technical Problem

An unsealed part of a mouthpiece may corrode when coming into contact with the fiber of a reinforcing layer and/or the outside.

An object of the present disclosure is to provide a tank that can lead to suppressed corrosion on a mouthpiece.

### Solution to Problem

The present application discloses a tank comprising: a liner; and a mouthpiece disposed in an opening part of the liner, wherein a surface of the mouthpiece is aluminum, an anodized layer is provided over the surface of the mouthpiece, the anodized layer is partially a sealing part where a sealing layer is formed, and a rest of the anodized layer is partially a non-sealing part where the sealing layer is not formed, and the liner is disposed so as to straddle a boundary between the sealing part and the non-sealing part.

The tank may be composed in such a way that the mouthpiece has a steplike part, the sealing part and the non-sealing part are disposed on a bottom face of the steplike part, and the liner is disposed so as to cover the bottom face.

### Advantageous Effects

According to the present disclosure, the corrosion resistance of a mouthpiece can be ensured more definitely because a liner is disposed so as to straddle the boundary between the area formed by only an anodized layer (non-sealing part), and a sealing layer (sealing part) in the mouthpiece.

### BRIEF DESCRIPTION OF DRAWINGS

FIG. 1 shows an external appearance of a tank;

FIG. 2 is a partial cross-sectional view of the tank;

FIG. 3 illustrates an anodized layer;

FIG. 4 illustrates a sealing layer;

FIG. 5 is a partially enlarged view of FIG. 2;

FIG. 6 illustrates disposition of a sealing part and a non-sealing part; and

FIG. 7 illustrates disposition of the sealing part and the non-sealing part according to another embodiment.

### DESCRIPTION OF EMBODIMENTS

### 1. Basic Structure of High-Pressure Tank

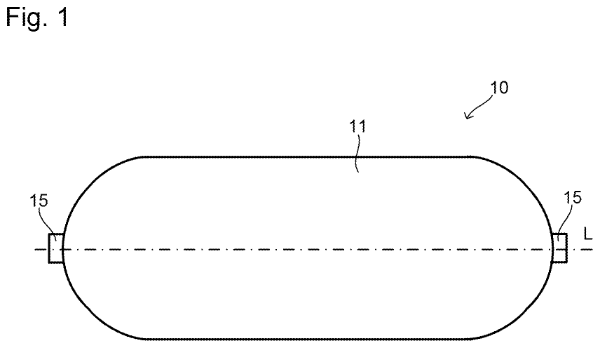

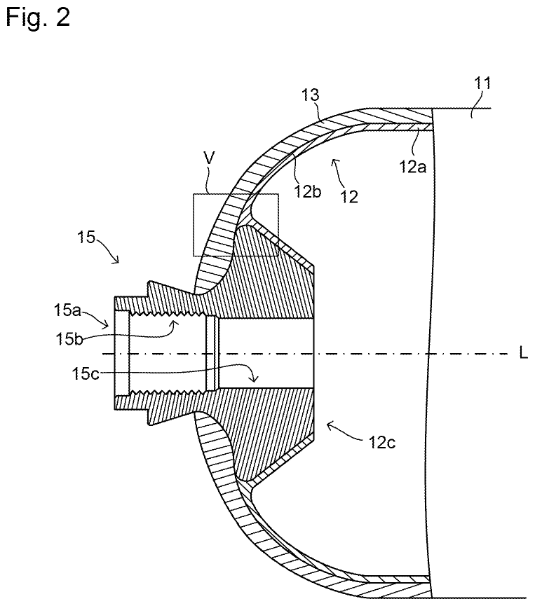

FIG. 1 schematically shows an external appearance of a high-pressure tank 10 according to one embodiment. FIG. 2 shows a partial cross section of the high-pressure tank 10 taken along the axis L: this partial cross section includes a part around one of mouthpieces 15 to which a valve is to be fitted. As can be seen from these drawings, in this embodiment, the high-pressure tank 10 includes a tank body 11 and the mouthpieces 15. The basic structure of each of them will be described below.

1.1. Tank Body

The tank body 11 holds a matter to be housed therein (such as hydrogen) without a leak, and has enough strength to bear a high-pressure state thereinside. For this, in this embodiment, the tank body 11 is provided with a liner 12, and a reinforcing layer 13 disposed around the periphery of the liner 12.

1.1.1 Liner

The liner 12 is a hollow member defining the space inside the high-pressure tank 10, and in this embodiment, is cylindrical. The liner 12 is such that the openings at the respective ends of a trunk 12a thereof which has an approximately uniform diameter are narrowed by dome-like side end parts 12b thereof, and the mouthpieces 15 are disposed in narrowed openings 12c thereof.

Any known material can be used for the liner 12 as long as allowing the matter housed in the internal space of the liner 12 (such as hydrogen) to be held without a leak. Specifically, for example, the liner 12 is formed from a nylon resin or a polyethylene synthetic resin.

The thickness of the liner 12 is not particularly limited, and is preferably 0.5 mm to 1.0 mm.

1.1.2. Reinforcing Layer

The reinforcing layer 13 is such that plural layers of fiber bundles that are made from a carbon fiber or the like and that are impregnated with a cured resin are laminated. Specifically, the reinforcing layer 13 is formed by winding the fiber bundles around the periphery of the liner 12 until the plural layers of the wound fiber bundles have a predetermined thickness. The thickness of the reinforcing layer 13 is not particularly limited because determined according to necessary strength, and is approximately 10 mm to 30 mm.

As the fiber with which the resin is reinforced, a carbon fiber or an aramid fiber (such as a poly-paraphenylene terephthalamide fiber) can be used. A glass fiber may be used as the fiber with which the resin is reinforced. As the resin reinforced with the fiber, a thermosetting resin such as an epoxy resin, an epoxy acrylate resin, and a polyester resin can be used.

1.2. Mouthpiece

The mouthpieces 15 are members fitted to the two openings of the liner 12, respectively. One of the mouthpieces 15 functions as an opening via which the inside and the outside of the high-pressure tank 10 communicate with each other. In addition, a valve is to be fitted to the one mouthpiece 15.

Therefore, at least the one of the mouthpieces 15, to which a valve is to be fitted, is provided with the hole 15a that has a circular cross section and that is for disposing a valve.

An inner face of the hole 15a is provided with a female thread 15b that corresponds to a male screw of a valve. A valve is fixed to the mouthpiece 15 by combining a male screw thereof with this female thread 15b.

The inner surface of the hole 15a has a smooth sealed face 15c on a side closer to the tank than the female thread 15b is (high-pressure side). If a sealing member provided around the circumference of a valve comes into contact with this sealed face 15c, the high-pressure tank 10 becomes airtight (is sealed).

The material forming the mouthpieces 15 includes aluminum since the mouthpieces 15 each include an anodized layer on aluminum as described later. The material is not particularly limited as long as being an aluminum-based material that can be anodized and that is capable of leading to enough strength.

### 2. Surface Structure of Mouthpieces and Relation thereof to Liner

2.1. Surface Structure of Mouthpieces

2.1.1. Anodized Layer

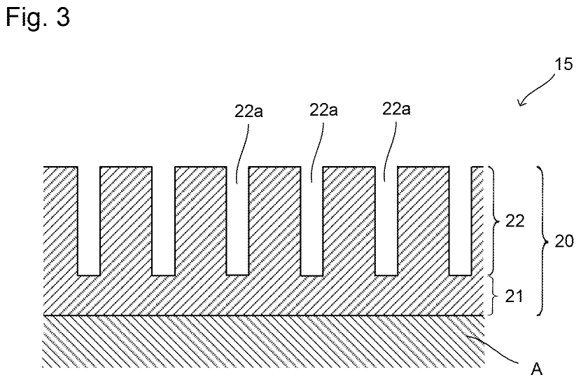

An anodized layer is formed on the surface of each of the mouthpieces 15. An anodized layer is a layer formed by an oxide film that is formed on the surface of aluminum by anodizing. FIG. 3 shows an enlarged cross section of part of an anodized layer 20. The anodized layer 20 includes a barrier layer 21 layered on a base material A that forms the mouthpieces 15, and a porous layer 22 continuously formed from the barrier layer 21. The porous layer 22 has a structure of an aggregate of hexagonal column structures. Each of the hexagonal column structures has a micropore 22a extending to the vicinity of the barrier layer 21. The diameter of the pore 22a is approximately several to several ten micrometers.

The anodized layer 20 as described causes the resin forming the liner 12 to penetrate into these micropores 22a at the time of insert molding, and thus, to fill the pores 22a. The anchoring effect leads to firm adhesion between the mouthpieces 15 and the liner 12.

2.1.2. Sealing Layer

The mouthpieces 15 each has the anodized layer 20 on the surface thereof. This surface partially has a sealing layer 25 that is a layer with which the openings of the pores 22a in the anodized layer 20 are sealed up so as not to appear on the surface. The pores 22a in the anodized layer 20 can lead to increased adhesive strength because the resin of the liner 12 penetrates thereinto as described above. The pores 22a in the area not in contact with the liner 12 are however in contact with the reinforcing layer and/or the outside air to cause corrosion to advance. Thus, in this area, the sealing layer is formed on the anodized layer 20 for making a part with which the pores 22a are sealed up.

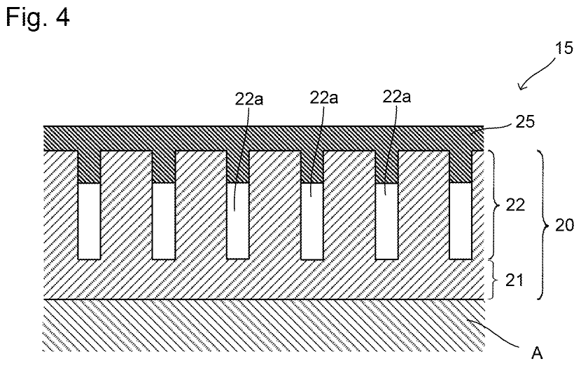

FIG. 4 is a partially enlarged view of the area where the sealing layer 25 is formed.

The sealing layer 25 is formed by sealing. In this sealing, aluminum oxide of the anodized layer 20 partially forms a hydrated alumina layer of alumina monohydrate (boehmite, Al₂O₃·H₂O), or alumina trihydrate (bayerite, Al₂O₃·3H₂O), so that the micropores 22a are sealed up.

Here, on the surface of each of the mouthpieces 15, the area where the sealing layer 25 is formed is expressed as a sealing part F, and the area where the sealing layer is not formed is expressed as a non-sealing part N.

2.1.3. Disposition of Sealing Part and Non-Sealing Part (Relation thereof to Liner)

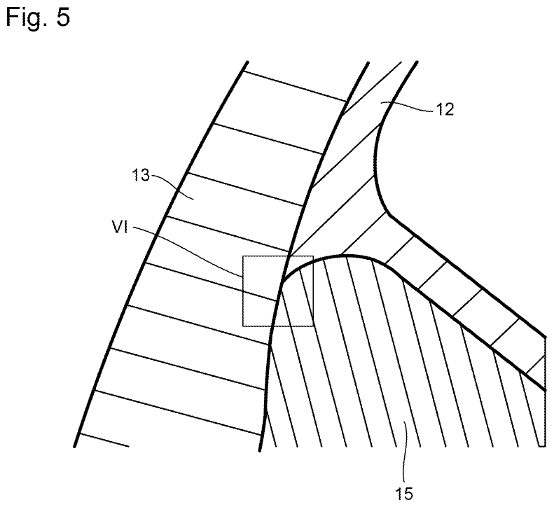

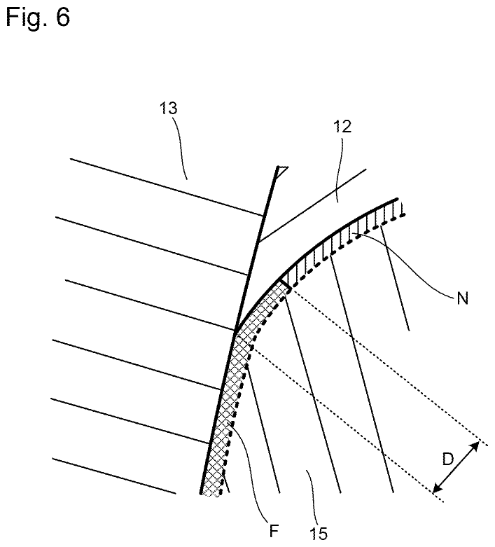

The disposition of the sealing part F and the non-sealing part N is determined as necessary. A basic approach is such that the area coming into contact with the liner 12 is formed to be the non-sealing part N, and the area not in contact with the liner 12 is at least partially formed to be the sealing part F. In contrast, in the part shown by V in FIG. 2, the liner 12, the reinforcing layer 13, and the mouthpiece 15 are in close vicinity to each other, and thus, a strict application of the basic approach may cause corrosion. Therefore, the structure in the present embodiment is as follows. FIG. 5 is an enlarged view of the part shown by V in FIG. 2. FIG. 6 is an enlarged view of the part shown by VI in FIG. 5. FIG. 6 shows disposition of the sealing part F and the non-sealing part N.

In this embodiment, in principle, the area in contact with the liner 12 is formed to be the non-sealing part N, and the area other than the former area is at least partially formed to be the sealing part F. On the contrary, at the boundary part of the non-sealing part N and the sealing part F, the liner 12 is disposed so as to straddle the boundary between the sealing part F and the non-sealing part N, which is different from the above principle. This can lead to more definite suppression of corrosion even at the boundary part of the non-sealing part N and the sealing part F.

The size of the part of the liner 12 which is in contact with the sealing part F shown by D in FIG. 6 is not particularly limited as long as larger than 0 mm, and is preferably at least 1 mm, and more preferably at least 3 mm.

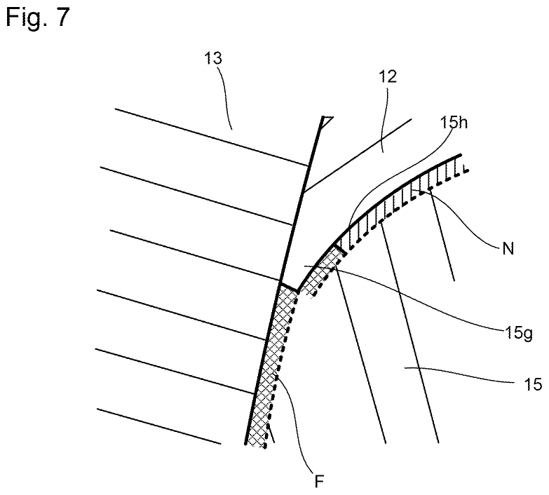

FIG. 7 illustrates another embodiment from the same viewpoint as FIG. 6. In the embodiment shown in FIG. 7, each of the mouthpieces 15 is provided with a steplike part 15g, and a bottom face 15h of the steplike part 15g is at least partially formed to be the sealing part F. The entire bottom face 15h of the steplike part 15 is covered with the liner 12. This can also lead to suppressed corrosion at the boundary part because the liner 12 is disposed so as to straddle the boundary part of the sealing part F and the non-sealing part N. Disposing the liner 12 in such a way that the liner 12 covers the bottom face 15h of the steplike part 15g can also lead to suppressed lifting of the liner 12 so that the boundary between the non-sealing part N and the sealing part F can be definitely covered with the liner 12.

### 3. Method of Producing Tank

For example, the above-described tank 10 can be produced as follows. A method of producing the tank S1 according to one example comprises an anodizing step, the step of forming a mask, a sealing step, the step of insert molding, the step of joining liner members, and the step of forming the reinforcing layer. Hereinafter each of the steps will be described.

3.1. Anodizing Step

In the anodizing step, the anodized layer 20 is formed on the aluminum of the mouthpieces by anodizing the mouthpieces. The reaction formulae in the anodizing are as follows.

anode: 2Al+3H₂O→6e⁻+Al₂O₃+6H⁺

cathode: 6H⁺+6e⁻→3H₂

For the anodizing, a bath, a treatment liquid, the mouthpieces 15 as anodes, a cathode, and a DC power source are prepared. As a treatment liquid as used herein, a solution of dilute sulfuric acid or oxalic acid can be used. In the case where the anodized layer is not formed over the inner face of the hole 15a of the one mouthpiece 15, one may place a member with which the hole 15a is blocked up to seal up the hole 15a, so that the treatment liquid does not penetrate. For example, a blocking member as used herein is formed from a resin. As a cathode as used herein, lead or carbon can be used. The voltage of a DC power source as used herein depends on the concentration of the treatment liquid. For example, this voltage is approximately 15 V to 30 V when the treatment liquid is dilute sulfuric acid, and is approximately 20 V to 60 V when the treatment liquid is oxalic acid.

The anodizing is performed by putting the mouthpieces 15 in the treatment liquid in the bath and sending electricity.

3.2. Step of Forming Mask

In the step of forming a mask, a mask is placed on the area of each of the anodized layers 20 where the sealing layer 25 is not formed. In this step of forming a mask, as described above, a mask is formed on the area to be the non-sealing part N without any mask formed on the area to be the sealing part F. 3.3. Sealing Step

In the sealing step, the area of each of the anodized layers 20 where no mask is placed is sealed. In the sealing, specifically, the anodized layers 20 are processed with boiling water, a high temperature aqueous solution of nickel acetate, or high temperature water vapor, and thereby, form a hydrated alumina. Through this sealing, aluminum oxide of each of the anodized layers 20 partially forms alumina monohydrate (boehmite, Al₂O₃·H₂O), or alumina trihydrate (bayerite, Al₂O₃·3H₂O), so that the micropore 22a are sealed up as shown in FIG. 4. After the sealing, the mask is removed.

3.4. Step of Insert Molding

In the step of insert molding, the liner 12 where the mouthpieces 15 are disposed is formed by insert molding. In this step, a liner member having one of the mouthpieces 15 is made by putting the mouthpiece 15 onto a metal mold (not shown) as an insert part, and injection-molding a resin. Here, the liner member is half the total length (size along the axis L) of the liner 12. Further, another half of a liner member having the other mouthpiece 15 (mouthpiece without any hole) is made in the same way. Examples of the injected resin include thermosetting resins such as nylon and polyethylene as described above.

3.5. Step of Joining Liner Members

In the step of joining liner members, the two liner members made in the insert step are joined.

In this step, an end part of the liner of one of the liner members is made to adjoin an end part of the liner of the other liner member, and the adjoining part of the two liners are irradiated with a laser with, for example, a laser torch. This results in the two liner members welded by the heated resin of the joined part of the two liner members.

In this case, preferably, one of the liner members is formed from a laser absorptive resin, and the other liner member is formed from a laser transmissive resin. This makes it easy to weld the two liner members. Further, in this case, preferably, the same resin material is used for the two liner members, and a pigment is added to the resin material for one of the liner members to give the one liner member laser absorbency. This is because there is no difference in strength between the two liner members when the same material is used for the two liner members. As a pigment as used herein, for example, carbon black or ferrous oxide (FeO) can be used.

3.6. Step of Forming Reinforcing Layer

In the step of forming the reinforcing layer, fiber bundles impregnated with a resin are wound around the outer face of each of the mouthpieces 15 which is outside the liner 12, and the liner 12. The mechanical properties of the tank can be adjusted according to the winding manner of the fiber bundles. After this, the resin in the wound fiber, which is impregnated with the resin, is heat-set to form the reinforcing layer 13.

### 4. Effect Etc.

According to the present disclosure, corrosion can be suppressed even at a part where a liner, a reinforcing layer, and a mouthpiece are in close vicinity to each other.

### REFERENCE SIGNS LIST

10 high-pressure tank
11 tank body
12 liner
13 reinforcing layer
15 mouthpiece
20 anodized layer
25 sealing layer

What is claimed is:

1. A tank comprising:
a liner; and
a mouthpiece disposed in an opening part of the liner, wherein
a surface of the mouthpiece is aluminum,
an anodized layer is provided over the surface of the mouthpiece,
the anodized layer is partially a sealing part where a sealing layer is formed, and a rest of the anodized layer is partially a non-sealing part where the sealing layer is not formed, and
the liner is disposed so as to straddle a boundary between the sealing part and the non-sealing part.

2. The tank according to claim 1, wherein
the mouthpiece has a steplike part,
the sealing part and the non-sealing part are disposed on a bottom face of the steplike part, and
the liner is disposed so as to cover the bottom face.
